(19) United States
(12) Patent Application Publication
(10) Pub. No.: US 2007/0198540 A1
(43) Pub. Date: Aug. 23, 2007

(54) Non-bindable mount in a shared mount tree

(76) Inventors: John T. Kohl, Arlington, MA (US); Ramachandra N. Pai, Beaverton, OR (US)

Correspondence Address: LIEBERMAN & BRANDSDORFER, LLC, 802 STILL CREEK LANE, GAITHERSBURG, MD, 20878, US

(21) Appl. No.: 11/344,652

(22) Filed: Feb. 1, 2006

(51) Int. Cl. G06F 7/00

(52) U.S. Cl. 707/100

(57) ABSTRACT

A system and method are provided for mitigating propagation of select mounts in a shared mount tree. One or more mounts in the mount tree may be designated as non-bindable. Each non-bindable mount cannot be mirrored to a mount point through a mirror operation of a mount subtree in which the non-bindable mount resides. Similarly, each non-bindable mount prevents a submount residing on the non-bindable mount to be mirrored. However, the non-bindable mount and it's submounts may be mirrored when the entire mount tree is mirrored and attached to a mount point that resides in a no mount tree that acts as a pivot for a new mount tree created through a mirror operation. A mirror of the non-bindable mount maintains the properties of the non-bindable mount.

### BACKGROUND OF THE INVENTION

1. Technical Field

This invention relates to a method and system for employing an non-bindable mount in a shared mount tree. More specifically, the non-bindable mount enables a mirror of the mount tree to be mounted to a specified directory in its entirety with the exception of each mount in the tree that is designated as non-bindable.

2. Description Of The Prior Art

In a server, a filesystem is provided, wherein the filesystem is in the form of a subtree rooted to a particular directory. The root of the tree describes the filesystem rooted at the root directory and provides all clients with the capability of having a consistent view of the name tree. There are two categories of filesystems, physical and logical. A physical filesystem is generally in the form of storage space on a computer that usually resides on several devices. This encompasses several different types of media, including hard drives, CD-ROM drives, and floppy drives. Each of these devices has a distinct physical filesystem associated with it. A logical filesystem is generally in the form of an interface to each physical filesystem. As far as the user is concerned, each physical filesystem is accessed using the same set of physical filesystem calls. The aim is to provide as consistent an interface as possible. It is this consistency that allows the set of physical filesystems to be represented as a single directory hierarchy.

In a rooted filesystem, files can be spread out over several devices. Mounting is the process of associating a filesystem to a directory or directory structure. A mount command serves to attach a file system found on a device to the server file system, and serves as a mechanism to support transparent access of contents of a directory tree contained in a filesystem. Conversely, an umount command is a disassociation of a filesystem associated with a directory or directory structure. In effect, an unmount command will detach the file system from the directory or directory structure.

A filesystem may be mounted anywhere in the directory tree. It does not necessarily have to be mounted on the root directory of the filesystem. For example, it is possible to have filesystem A mounted at a mount point on the root filesystem, and filesystem B mounted at a mount point contained in filesystem A. The mount command takes a filesystem and maps it to an existing directory in the tree, called the mount point. A tree depicting the mount points of a filesystem to a directory is known as a mount tree. Once a filesystem is mounted at a given mount point, the mount tree of that filesystem is accessed as if it is contained in the directory serving as the mount point. A set of mounts that propagate mount events to each other is known as a peer group. This enables mounts at one directory in the mount tree to be reflected in one or more other directories in the mount tree. Accordingly, a mount provides a mechanism to transparently access the contents of a mount tree contained in a filesystem.

In addition to the mount command, a bind command is provided to support replicating a mounted subtree in the filesystem to a new location. Following the bind command and replication of the subtree, the tree will be available from both the old and new directory. There are two general categories for a bind mount: a private mount and a shared mount. A private bind mount is a mount that does not propagate mount events, and when cloned creates a new mount of the same type. A shared bind mount is a mount that is a member of a peer group, i.e. a set of mounts that propagate mount events to each other. When a peer group is replicated, i.e. cloned, a new mount is created with all members of the new mount belonging to the same peer group.

FIG. 1 is a block diagram (10) of a filesystem tree having a root directory (12) and three subdirectories S₁ (14), S₂ (16), and S₃ (18). The root directory (12) is a private mount and therefore will not be replicated, i.e. propagated. A filesystem, F₁, is mounted as a shared mount to the first subdirectory S₁(14). In tree form, F₁ is located at /root/S₁. F₁ is marked as shared (20). FIG. 2 is a block diagram (30) of the mount tree of FIG. 1 after a replicate mount of the first subdirectory, S₁,(14) to the third subdirectory, S₃, (18). As shown, the root directory (12) and subdirectories S₁ (14) and S₂ (16) remain constant. Filesystem F₁ (32) is shown replicated to the third subdirectory, S₃, (18). Item (34) in the first subdirectory, S₁, (14) and item (36) in the third subdirectory, S₃, (18) indicate that filesystem F₁ is shared and is part of the same peer group. Furthermore, item (38) in the first subdirectory, S₁, (14) indicates that filesystem F₁ at this location is the first replication thereof, and item (40) in the third subdirectory, S₃, (18) indicates that filesystem F₁ at this location is the second replication thereof. To extrapolate the shared mount further, creation of a new subdirectory emanating from the first subdirectory, S₁, (14) in FIG. 2 results in creation of the same subdirectory emanating from the third subdirectory, S₃, (18) since filesystem F₁ was created as a shared mount and replicated to the third subdirectory, S₃, (18). FIG. 3 is a block diagram (50) illustrating the mount tree (30) of FIG. 2 with a new subdirectory. As shown, the root directory (52) and the original three subdirectories S₁ (54), S₂ (56), and S₃ (58) remain as in FIG. 1, and the mount of filesystem F₁ remains as in FIG. 2. The first subdirectory S₁ (54) is shown with a subdirectory T₁ (64) emanating therefrom. Similarly, the third subdirectory S₃ (58) is shown with a subdirectory T₃ (68) emanating therefrom. If another filesystem is to be mounted to one of the new subdirectories T₁ (64) or T₃ (68), this new filesystem would be replicated based on the characteristic of a shared mount. FIG. 4 is a block diagram (70) illustrating mounting of a new filesystem, F₂, to the new subdirectory T₁ (64) mounted to the first subdirectory S₁ (54). As noted at item (74), F₂ is originally mounted in the new subdirectory T₁ (64) and is part of a second peer group (76). Similarly, F₂ is automatically replicated (78) to the new subdirectory T₃ (68) and is part of the second peer group (80). F₂ in the new subdirectory T₃ (68) is a replica. The replication is automatic in the new subdirectory T₁(64) based upon the prior shared mount present in subdirectories S₁(54) and S₃(58). Accordingly, each shared mount within a mount tree is replicated based upon the characteristics of a shared mount.

FIG. 5 is a block diagram (100) of a tree structure showing a root directory (102), a first subdirectory, X₁, (104), and a second subdirectory, X₂, (106) with each directory having a filesystem mounted therein and each mount designated as a shared mount. The first subdirectory (104) has a filesystem, F₁, mounted therein, and the second subdirectory (106) has a filesystem, F₂, mounted therein. In addition, the first subdirectory (104) has three subdirectories S₁ (112), S₂ (114), and S₃ (116) emanating therefrom, and the second subdirectory (106) has three subdirectories emanating therefrom T₁ (122), T₂ (124), and T₃ (126). Each of directory X₁ (104) and X₂ (106) in the mount tree structure has at least one filesystem mounted thereto and is marked as a shared mount, including the root directory (102). As such, replication of the mount tree will result in a clone of all the mounts in the mount tree. FIG. 6 is a block diagram (150) illustrating the tree structure following a replication of any of the mounts to subdirectory S₁ (112). In a further extrapolation of the shared mount of FIG. 5, FIG. 7 is a block diagram (200) illustrating the tree structure following a replication of the mount from subdirectory (112) to subdirectory (114). The quantity of mounts in a shared mount tree, V, is an exponential function of the generation level reflected as:

V[i]=i*V[i−1]

where i represents an instance of the replication and mount attempt.

There are advantages of a mount tree having a shared mount. At the same time there are significant drawbacks associated with such a mount tree. One particular advantage of a mount tree having shared mount is that mount events in any one replica of the mount tree propagates to all other replicas. The benefit of a mount tree comprised of shared mounts, enables a complete replication of the mount tree across the filesystem. However, a significant drawback associated with replicating a mount tree while preserving the properties of a shared mount is the exponential growth of the mount tree. Such exponential growth is caused with a replicate mount of the shared mount tree within the same shared tree multiple times, which can potentially result in an unmanageable mount tree. Accordingly, there is a need for a solution associated with replication of a mount tree that maintains the benefit of the shared mount while mitigating the exponential growth of the mount tree.

### SUMMARY OF THE INVENTION

This invention comprises a method and system for a mount tree to support a mount command that mitigates propagation of a specified filesystem mounted in one or more select directories, while support propagation of all other filesystems mounted in one or more non-select directories of the mount tree.

In one aspect of the invention, a method is provided for replicating a mount tree. A mount tree is created with at least one filesystem mounted in a root directory and marked as shared. At least one filesystem is mounted to a select directory in communication with the root directory and marked as non-bindable. The non-bindable mount includes the following semantics: disallows the marked non-bindable mount to be mirrored through a mirror operation of a mount subtree in which the non-bindable mount resides, disallows submounts residing on the marked non-bindable mount to be mirrored through a mirror operation of a mount subtree in which the non-bindable mount resides; and allows the non-bindable mount and any submounts attached to the non-bindable mount to be mirrored when the mount tree is mirrored in its entirety and attached to a self contained mount point that functions as a pivot for a new mount tree, wherein the mirrored non-bindable mount creates a new non-bindable mount.

In another aspect of the invention, a mount tree is provided with at least one filesystem mounted in a root directory marked shared, and at least one filesystem mounted to a select directory in communication with the root directory and marked as non-bindable. The non-bindable mount has the following semantics: the non-bindable mount cannot be mirrored through a mirror operation of a mount subtree in which the non-bindable mount resides; a submount residing on the marked mount cannot be mirrored through a mirror operation of a mount subtree in which the non-bindable mount resides; and the non-bindable mount and any submounts attached to the non-bindable mount cannot be mirrored when said mount tree is mirrored in its entirety and attached to a self contained mount point that functions as a pivot for a new mount tree, wherein the mirrored non-bindable mount creates a new non-bindable mount.

In yet another aspect of the invention, an article is provided with a computer readable medium. Means in the medium are provided for creating a mount tree with at least one filesystem mounted in a root directory and marked as shared, and at least one filesystem mounted to a select directory in communication with the root directory and marked as non-bindable. The non-bindable mount has the following semantics: the non-bindable mount cannot be mirrored through a mirror operation of a mount subtree in which the non-bindable mount resides; a submount residing on the marked mount cannot be mirrored through a mirror operation of a mount subtree in which the non-bindable mount resides; and the non-bindable mount and any submounts attached to the non-bindable mount cannot be mirrored when said mount tree is mirrored in its entirety and attached to a self contained mount point that functions as a pivot for a new mount tree, wherein the mirrored non-bindable mount creates a new non-bindable mount.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a prior art mount tree with a private mount.

FIG. 2 is a block diagram of the prior art mount tree of FIG. 1 replicated.

FIG. 3 is a block diagram of the prior art mount tree of FIG. 2 replicated.

FIG. 4 is a block diagram of the prior art mount tree of FIG. 3 replicated.

FIG. 5 is a block diagram of a prior art mount tree with all mounts in the tree designated as shared.

FIG. 6 is a block diagram of the prior art mount tree of FIG. 5 replicated.

FIG. 7 is a block diagram of the prior art mount tree of FIG. 6 replicated.

FIG. 8 is a flow chart for replicating a mount tree with a non-bindable mount according to the preferred embodiment of this invention, and is suggested for printing on the first page of the issued patent.

FIG. 9 is a block diagram of a mount tree with a non-bindable mount.

FIG. 10 is a block diagram of a first view of a mount sub-tree from FIG. 9.

FIG. 11 is a block diagram of the mount sub-tree of FIG. 9 mirrored multiple times.

FIG. 12 is a block diagram of a mount tree with a non-bindable mount and a self contained mount point.

FIG. 13 is a block diagram of a mount tree with a non-bindable mount mirrored to a self contained mount point.

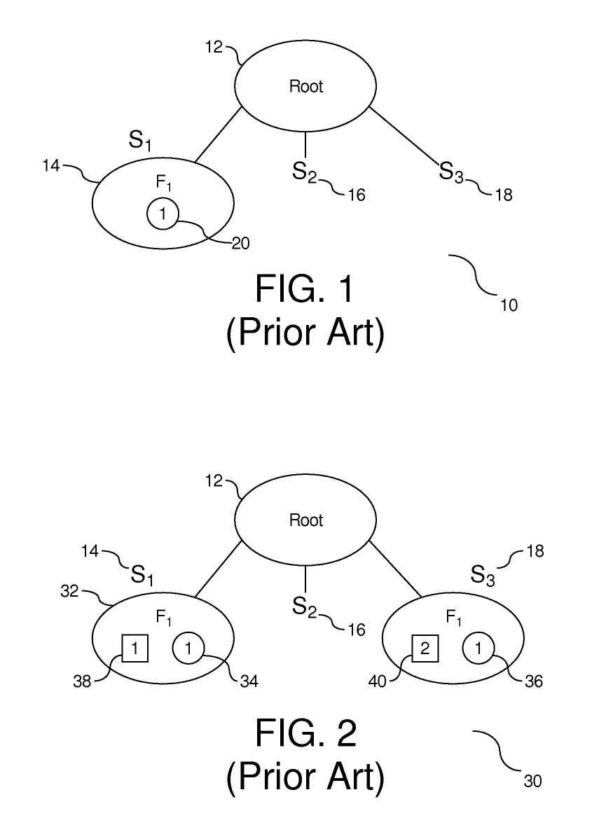

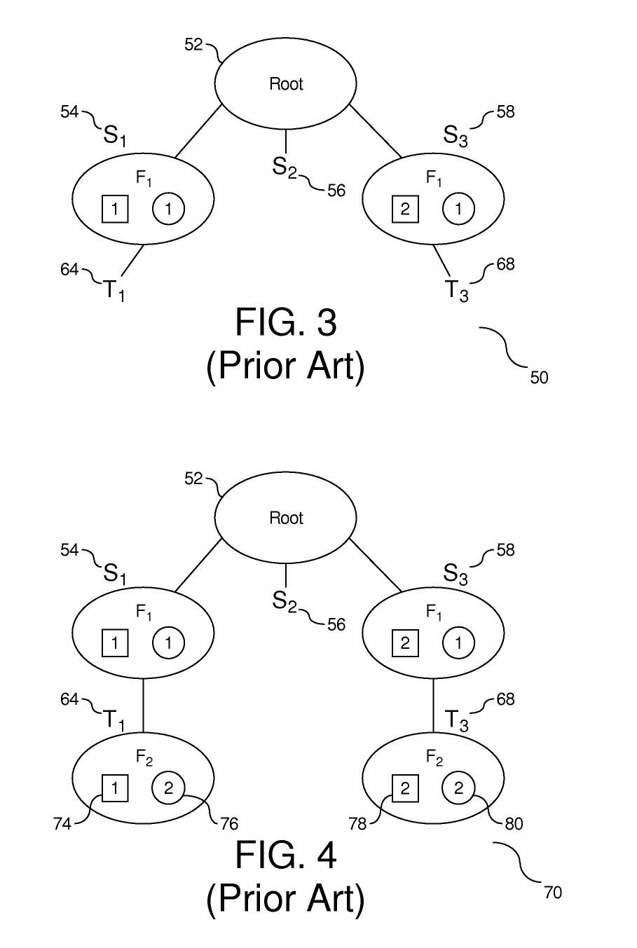

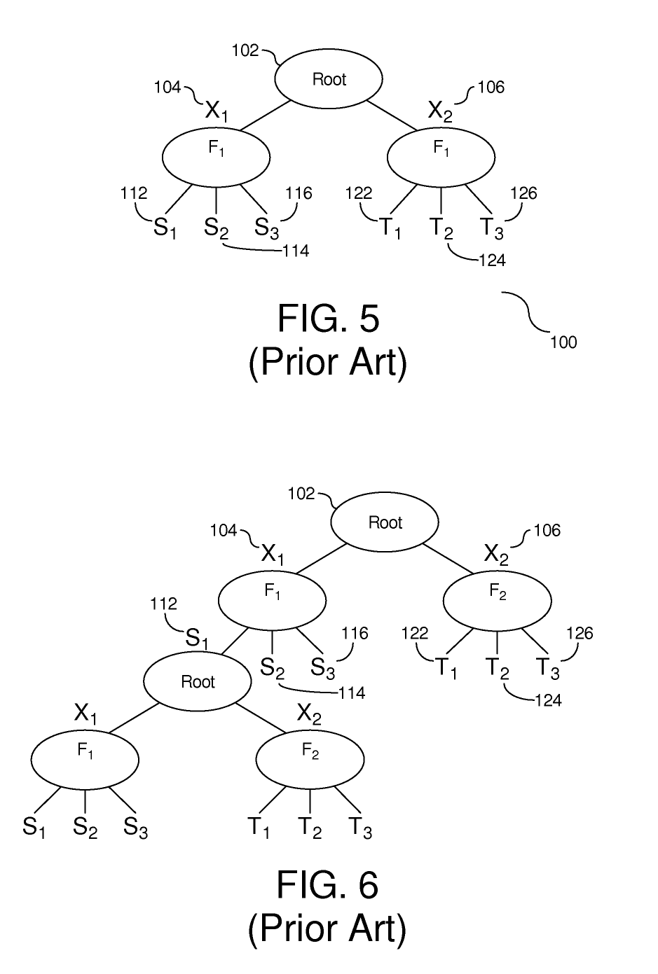

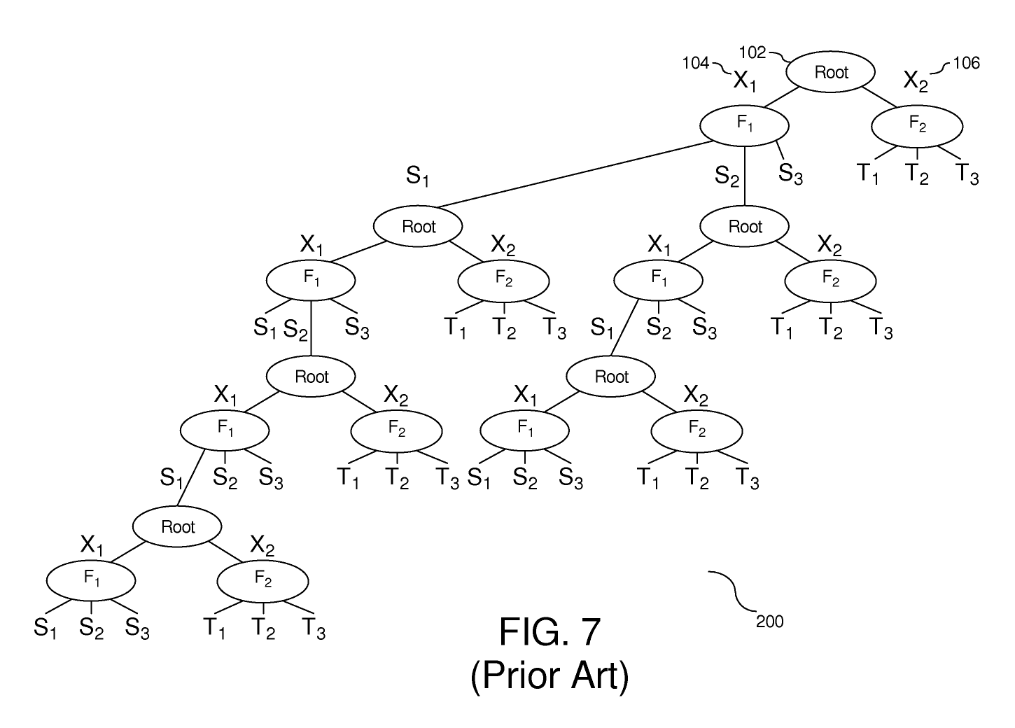

### DESCRIPTION OF THE PREFERRED EMBODIMENT

### Overview

A mount tree is provided with each mount in the mount tree being designated as a shared mount. This enables a mirror of the mount tree to any directory therein to replicate the entire mount tree at a separate location therein. One or more of the shared mounts may be designated as non-bindable to prevent propagation of the specified non bindable mount during a mirror of the mount tree. The remaining mounts of the tree which were designated as shared mounts are replicated during the mirror process.

### Technical Details

An non-bindable mount is provided within a shared mount tree. The semantics of an non-bindable mount disallows the mount or submounts residing on this mount to be mirrored, when attempted to be bound to a mount point, explicitly or implicitly, through a mirror operation of a mount subtree in which this mount resides. However, the semantics of the non-bindable mount allows the mount and its submounts to be mirrored, when the entire mount tree is mirrored and attached to a self-contained mount point, i.e. a mount point that resides in a no mount tree, that acts as the pivot for the new mount tree, where the mirror of the non-bindable mount inherits the same semantics.

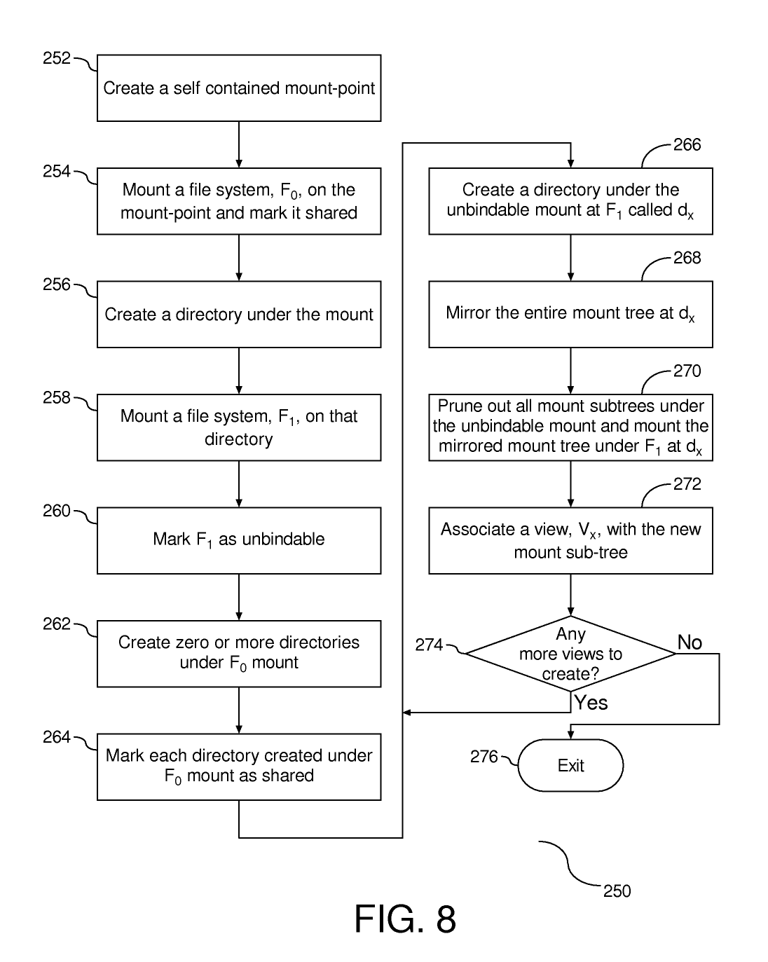

A view is a mapping from a set of tuples to a user defined unique name such that a tuples exists corresponding to every file in the system, wherein a tuple associates a version of a given file with the file name. In the mount tree replication of the preferred embodiment, a view is associated with each instance of the mount tree, and a tuple is an association of a version of a file with a version number to a user defined unique name. FIG. 8 is a flow chart (250) illustrating a process for creation of view of a mount tree with one or more filesystems in the mount tree designated as non-bindable. Initially a self contained mount point is created (252). In one embodiment, the self contained mount is a root directory. A filesystem, F₀, is mounted on the mount point and marked as shared (254). Following the mount at step (254), a directory under the initial mount from step (252) is created (256) and a filesystem, F₁, is mount on that directory (258). The filesystem, F₁, mount at step (258) is marked as non-bindable (260). Zero or more directories are then created under the initial mount point and the mounted filesystem, F₀, (262). One or more filesystems may be mounted in each of the directories created at step (262) with each mounted filesystem being marked as shared (264). Steps (252)-(264) outline the process for creation of an initial mount tree with one of the directories having at least one filesystem mount marked as non-bindable.

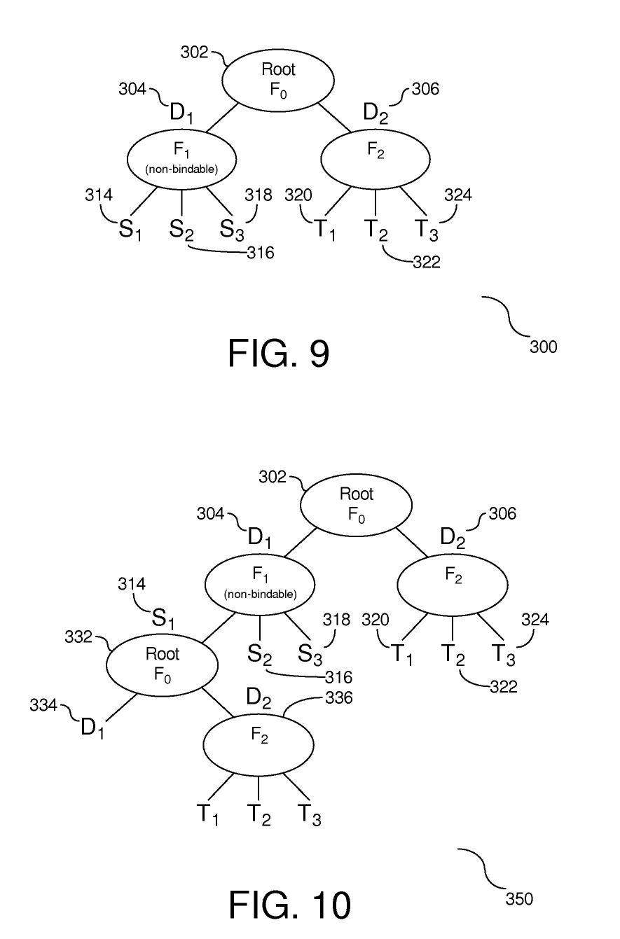

In the example presented, another level of the mount tree is created when a directory, dₓ, under the non-bindable mount, F₁ is created (266). FIG. 9 is a block diagram (300) showing the mount tree created at steps (252-266). As shown, there is a self contained mount point (302) with a filesystem, F₀, mounted and marked as shared. In addition, there are two directories D₁ (304) and D₂ (306) that are created under the self contained mount point (302). The first directory D₁ (304) has an non-bindable filesystem, F₁, mounted thereto, and the second directory D₂ (306) has a shared filesystem, F₂, mounted thereto. In addition, the first directory, D₁ , (304) has three subdirectories S₁ (314), S₂ (316), and S₃ (318), and the second directory, D₂, (306) has three subdirectories T₁ (320), T₂ (322), and T₃ (324). Accordingly, FIGS. 8 and 9 illustrated the creation and representation, respectively, of a mount tree with a non-bindable mount prior to a replication of the mount tree through a mirror process.

Replication of the mount tree is conducted through a mirror process wherein the entire mount tree is replicated and attached to a specified directory. In the case of the shared mount, mount events in any one replica propagate to all other replicas. Following step (266), replication of the mount tree is initiated through a mirror of the entire mount tree at directory dₓ (268). Since directory dₓ is an non-bindable mount, all mount subtrees under the non-bindable mount are pruned, and the mirrored mount tree is mounted on the directory created under F₁ (270), i.e. dₓ. Following the mirror process at step (270), a view, Vₓ, is associated with the new mount sub-tree (272). Thereafter, a test is conducted to determine if there are any more view of the mount sub-tree to be created (274). A positive response to the test at step (274) returns to step (266). Similarly, a negative response to the test at step (274) ends the process for creation of views of a mount tree.

FIG. 10 is a block diagram (350) showing the creation of the first view of the mount subtree at step (270) of FIG. 8. As shown, the mount tree of FIG. 9 has been replicated while propagating the designated shared mounts and pruning the designated non-bindable mount. The original view includes a self contained mount point (302) with a filesystem, F₀, mounted and marked as shared, two directories D₁ and D₂, (304) and (306) respectively, created under the self contained mount point (302), with the first directory D₁ (304) having a non-bindable filesystem, F₁, mounted thereto, and the second directory D₂ (306) having a shared filesystem, F₂, mounted thereto. In addition, the first directory D₁ (304) has three subdirectories S₁, S₂, and S3, (314), (316), and (318) respectively, and the second subdirectory D₂ (306) has three subdirectories T₁, T₂, and T₃, (320), (322), and (324) respectively. The mirror of this mount tree to subdirectory S₁ (314) is shown with a replicated mount point (302) designated as (332) with the filesystem F₀ mounted and marked as shared, and two directories (334) and (336) created under the mount point (322). The non-bindable filesystem from directory D₁ (304) is not mounted to (334) while preserving the directory structure of D₁, but the shared filesystem mounted to directory D₂ (306) is replicated at (336). Accordingly, as shown, marking a mounted filesystem as non-bindable enables the shared directory structure to be replicated while not replicating the designated non-bindable mount, thereby mitigating exponential growth in a mirror mount tree.

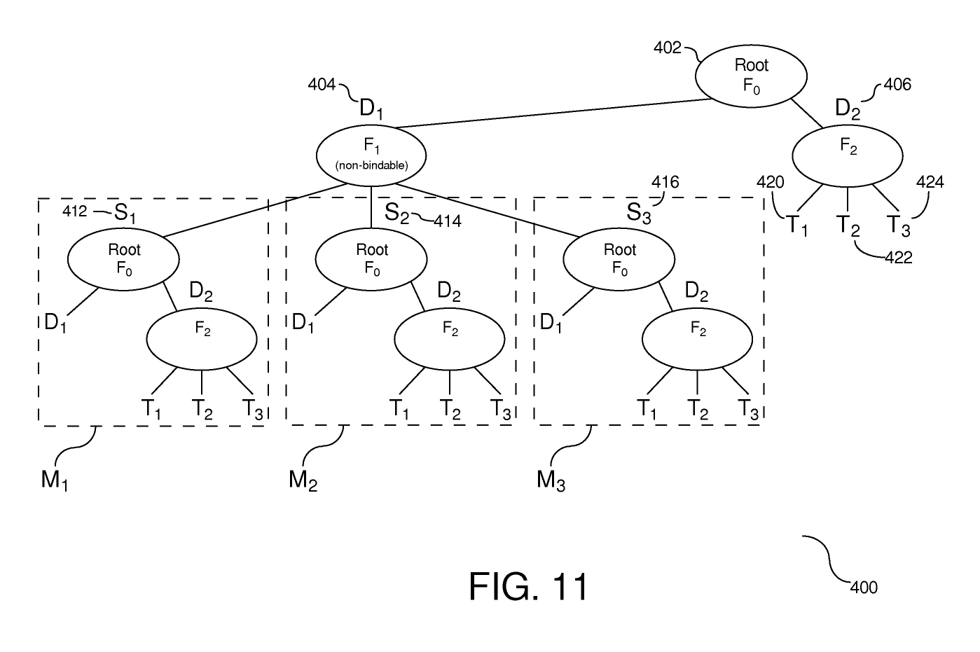

The mount tree replication process detailed in FIG. 8 may be extrapolated to create multiple views of the mount tree of FIG. 9. Each mirrored mount tree is mapped to a view. Upon request of a file by a server, the underlying filesystem may provide the version of the file corresponding to the view that the mirror of the mount tree supports. FIG. 11 is a block diagram (400) of the mount tree of FIG. 9 mirrored multiple times. As shown, there is an original self contained mount point (402) with a filesystem, F₀, mounted and marked as shared, two directories (404) and (406) created under the self contained mount point (402), with the first directory (404) having a non-bindable filesystem, F₁, mounted thereto, and the second directory (406) having a shared filesystem, F₂, mounted thereto. In addition, the first directory (404) has three subdirectories S₁ (412), S₂ (414), and S₃ (416), and the second subdirectory (406) has three subdirectories T₁ (420), T₂ (422), and T₃ (424). Three mirrors of this mount tree are shown, with one mirror, M₁, of the mount tree attached to subdirectory S₁ (412), the second mirror, M₂, of the mount tree attached to subdirectory (414), and the third mirror, M₃, of the mount tree attached to subdirectory (416). Each mirror is shown with a replicated mount point (402) with the filesystem F₀ mounted and marked as shared, and two directories created under the mount point (402) with the first directory having a non-bindable mount and the second directory having a shared mount. Similarly, the structure of the three subdirectories of the first directory are preserved, as well as the one subdirectory of the second directory. As illustrated, the non-bindable assignment to a filesystem mounted in a directory of a mount tree mitigates the exponential replication of the filesystem through the mirror replicated view.

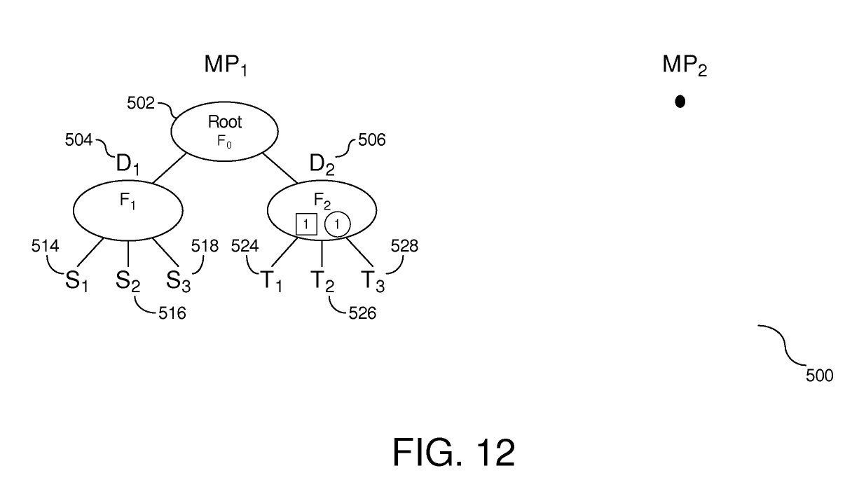

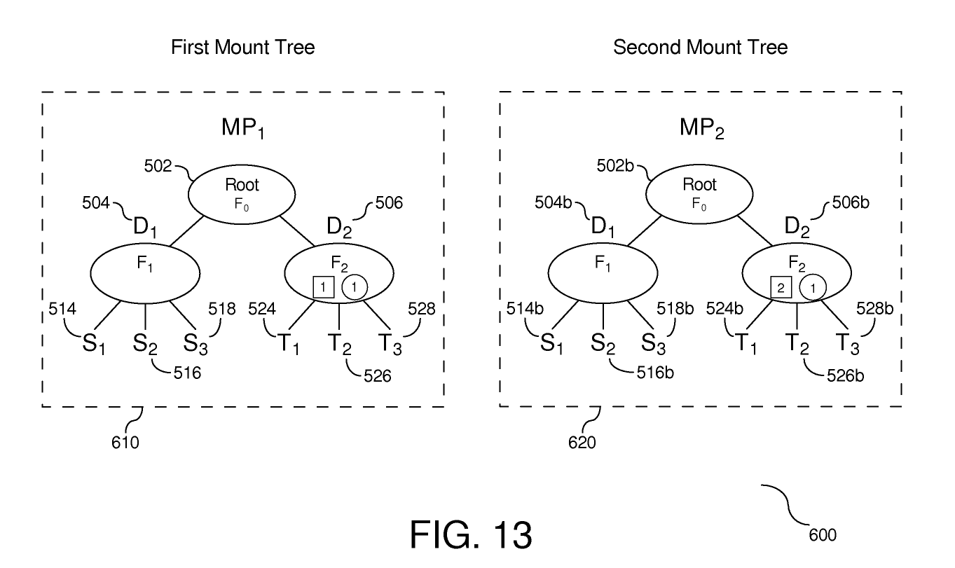

In one embodiment, the non-bindable mount allows the mount and its submounts to be mirrored when the entire mount tree is mirrored and attached to a self-contained mount point, i.e. a mount point that resides in a no mount tree. FIG. 12 is a block diagram (500) of a mount tree having two self contained mount points, a first self contained mount point MP₁ (502) and a second self contained mount point MP₂ (550). The first a self contained mount point (502) has a filesystem, F₀, mounted and marked as shared, two directories D₁ and D₂, (504) and (506) respectively, created under the self contained mount point (502). The first directory D₁ (504) has a non-bindable filesystem, F₁, mounted thereto, and the second directory D₂ (506) has a shared filesystem, F₂, mounted thereto. Filesystem F₂ mounted in directory D₂ (506) is the first mounting of this filesystem and is a member of the first peer group as noted with the typographic symbols. As is further illustrated, the first directory D₁ (504) has three subdirectories S₁ (514), S₂ (516), and S₃ (518), and the second directory D₂ (506) has three subdirectories T₁ (524), T₂ (526), and T₃ (528). The second self contained mount point, MP₂ (550) does not have any directories mounted thereto. FIG. 13 is a block diagram (600) showing replication of the mount tree of FIG. 12 having a non-bindable filesystem mounted therein mounted to the second self contained mount point, MP₂ (550). As shown, there are two mount trees in FIG. 12. The first mount tree (610) is a replica of the mount tree (500) in FIG. 11 and the numbering remains constant. The second mount tree (620) is a mirror of the first mount tree (610). For illustrative purposes the numbers have an “b” as a suffix indicating this is a mirror of the first mount tree. As shown as the second directory D₂ (506b), the mount filesystem, F₂, is the second replica of the filesystem as this is a mirror copy, and this mounted filesystem remains a member of the first peer group. Accordingly, as shown the semantics of a non-bindable mount allow the non-bindable mount and any submounts attached to said non-bindable mount to be mirrored when said mount tree is mirrored in its entirety and attached to a self contained mount point that functions as a pivot for a new mount tree with the mirrored non-bindable mount creating a new non-bindable mount.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Embodiments within the scope of the present invention also include articles of manufacture comprising program storage means having encoded therein program code.

Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, wireless and Ethernet adapters are just a few of the currently available types of network adapters.

### Alternative Embodiments

It will be appreciated that, although specific embodiments of the invention have been described herein for purposes of illustration, various modifications may be made without departing from the spirit and scope of the invention. In particular, while creating a replica of the mount tree having a non-bindable mount, the process may entail replicating the marked non-bindable mount and then removing all mounts under the mount that is marked non-bindable prior to completion of the replication process. Accordingly, the scope of protection of this invention is limited only by the following claims and their equivalents.

We claim:

1. A method for replicating a mount tree comprising:
creating a mount tree with at least one filesystem mounted in a root directory marked as shared; and
mounting at least one filesystem to a select directory in communication with said root directory and marking said mount as non-bindable, wherein said non-bindable mount includes semantics comprising:
disallowing said marked non-bindable mount to be mirrored through a mirror operation of a mount subtree in which said non-bindable mount resides;
disallowing submounts residing on said marked non-bindable mount to be mirrored through a mirror operation of a mount subtree in which said non-bindable mount resides; and
allowing said non-bindable mount and any submounts attached to said non-bindable mount to be mirrored when said mount tree is mirrored in its entirety and attached to a self contained mount point that functions as a pivot for a new mount tree, wherein said mirrored non-bindable mount creates a new non-bindable mount.

2. The method of claim 1, wherein said self contained mount point is a mount point that resides in a no mount tree.

3. The method of claim 1, further comprising creating an exact mirror of said mount tree under a specified location in said mount tree while preserving said semantic of said non-bindable mount in said tree.

4. The method of claim 3,wherein the step of creating an exact mirror of said mount tree includes creating said non-bindable mount at a specified location, and for each mirror of said mount tree creating: a mount point within said non-bindable mount, creating a mirror of said mount tree, and mounting said mirror on said mount point within said non-bindable mount.

5. The method of claim 4, further comprising creating multiple views of a file system represented by said mount tree by mapping each mirrored mount tree to a view of said file system.

6. A mount tree comprising:
at least one filesystem mounted in a root directory and said mount being marked shared; and
at least one filesystem mounted to a select directory in communication with the root directory and marked as non-bindable, wherein said non-bindable mount having semantics comprising:
said marked non-bindable mount being disallowed to be mirrored through a mirror operation of a mount subtree in which said non-bindable mount resides;
submounts residing on said marked mount being disallowed to be mirrored through a mirror operation of a mount subtree in which said non-bindable mount resides; and
said non-bindable mount and any submounts attached to said non-bindable mount being allowed to be mirrored when said mount tree is mirrored in its entirety and attached to a self contained mount point that functions as a pivot for a new mount tree, wherein said mirrored non-bindable mount creates a new non-bindable mount.

7. The mount tree of claim 6, wherein said self contained mount point is a mount point that resides in a no mount tree.

8. The mount tree of claim 6, further comprising an exact mirror of said mount tree adapted to be created under a specified location in said mount tree while said property of said non-bindable mount in said tree are preserved.

9. The mount tree of claim 8, wherein creation of the exact mirror of said mount tree with said non-bindable mount created at a specified location, and for each mirror of said mount tree creates: a mount point within said non-bindable mount, a mirror of said mount tree, and a mount of said mirror on said mount point within said non-bindable mount.

10. The mount tree of claim 9, further comprising a manager adapted to create multiple views of a filesystem represented by said mount tree by a map of each mirrored mount tree to a view of said filesystem.

11. An article comprising:
a computer readable medium;
means in the medium for creating a mount tree with at least one filesystem mounted in a root directory marked as shared; and
means in the medium for mounting at least one filesystem to a select directory in communication with the root directory and marking said mount as non-bindable, wherein said non-bindable mount includes semantics comprising:
disallowing said marked non-bindable mount to be mirrored through a mirror operation of a mount subtree in which said non-bindable mount resides;
disallowing submounts residing on said marked non-bindable mount to be mirrored through a mirror operation of a mount subtree in which said non-bindable mount resides; and
allowing said non-bindable mount and any submounts attached to said non-bindable mount to be mirrored when said mount tree is mirrored in its entirety and attached to a self contained mount point that functions as a pivot for a new mount tree, wherein said mirrored non-bindable mount creates a new non-bindable mount.

12. The article of claim 11, wherein said self contained mount point is a mount point that resides in a no mount tree.

13. The article of claim 11, further comprising means in the medium for creating an exact mirror of said mount tree under a specified location in said mount tree while preserving said semantics of said non-bindable mount in said tree.

14. The article of claim 13,wherein the means for of creating an exact mirror of said mount tree includes creating said non-bindable mount at a specified location, and for each mirror of said mount tree creating: a mount point within said non-bindable mount, creating a mirror of said mount tree, and mounting said mirror on said mount point within said non-bindable mount.

15. The article of claim 14, further comprising means in the medium for creating multiple views of a filesystem represented by said mount tree by mapping each mirrored mount tree to a view of said filesystem.
